(19) United States
(12) Patent Application Publication
(10) Pub. No.: US 2026/0322036 A1
(43) Pub. Date: Oct. 15, 2026

(54) CARD EDGE CONNECTOR WITH AN IMPROVED METAL KEY

(71) Applicants: Fuyu Electronic Technology (Huai'an) Co., Ltd., Huai'an (CN); FOXCONN INTERCONNECT TECHNOLOGY LIMITED, Grand Cayman (KY)

(72) Inventors: CHUN-LEI ZHOU, Huaian (CN); XUN WU, Huaian (CN); XIAO-HU YIN, Huaian (CN); XUE-WU BU, Kunshan (CN)

(21) Appl. No.: 19/647,883

(22) Filed: Apr. 15, 2026

(30) Foreign Application Priority Data
Apr. 15, 2025 (CN) 202510474560.9

(51) Int. Cl. H01R 13/642; H01R 12/72; H01R 12/73; H01R 13/504; H01R 13/516

(52) U.S. Cl. CPC H01R 13/642; H01R 12/721; H01R 12/725; H01R 12/737; H01R 13/504; H01R 13/516

(57) ABSTRACT

A card edge connector includes: an insulating housing having two sidewalls, a mating face, and a mating slot located between the two sidewalls penetrating through the mating face and defining a mating direction; plural conductive terminals located on the sidewalls and having contacting portions protruding into the mating slot; and a metal key located on the insulating housing. The metal key extends laterally across the mating slot and is embedded in the two sidewalls.

### BACKGROUND OF THE INVENTION

### 1. Field of the Invention

The present invention relates to a card edge connector with a metal key.

### 2. Description of Related Arts

Card edge connectors are commonly used in computers, for example, high-speed computer bus standard (Peripheral Component Interconnect Express, PCIe) connectors are used to connect the motherboard to external hardware devices. Generally, the interface of the external hardware device, such as a card, is inserted into the card edge connector to achieve electrical connection. The card edge connector has a key position to prevent reverse insertion of the card. A metal key is further sleeved at the key position to prevent wear of the plastic key position caused by card insertion. However, the metal key is currently formed by bending a metal sheet and assembled at the key position, which still poses risks of wear and detachment.

U.S. Pat. No. 7,442,093 discloses a card edge connector including a metallic key received in the insulating housing. The metallic key is inserted into a retaining hole discretely and has a recess thereof. A retaining section is retained in the recess and has a leg to connect with the mother board.

An improved card edge connector is desired.

### SUMMARY OF THE INVENTION

An object of the present invention is to provide a card edge connector with an improved metal key.

To achieve the above-mentioned object, a card edge connector comprises: an insulating housing having two sidewalls, a mating face, and a mating slot located between the two sidewalls penetrating through the mating face and defining a mating direction; a plurality of conductive terminals located on the sidewalls and having contacting portions protruding into the mating slot; and a metal key located on the insulating housing; wherein the metal key extends laterally across the mating slot and is embedded in the two sidewalls.

Other advantages and novel features of the invention will become more apparent from the following detailed description of the present embodiment when taken in conjunction with the accompanying drawings.

### BRIEF DESCRIPTION OF DRAWINGS

FIG. 1 is a perspective view of a card edge connector of an embodiment of the present application;

FIG. 2 is an exploded perspective view of the card edge connector in FIG. 1;

FIG. 3 is another exploded perspective view of the card edge connector FIG. 1;

FIG. 4 is another exploded perspective view of the metal key and the insulating housing in FIG. 2;

FIG. 5 is a top view of a left part of the card edge connector without the metal shell in FIG. 2; and

FIG. 6 is a cross sectional view of the card edge connector in FIG. 1 taken along a line A-A.

### DETAILED DESCRIPTION OF THE PREFERRED EMBODIMENT

Reference will now be made to the drawing figures to describe a preferred embodiment of the present invention in detail.

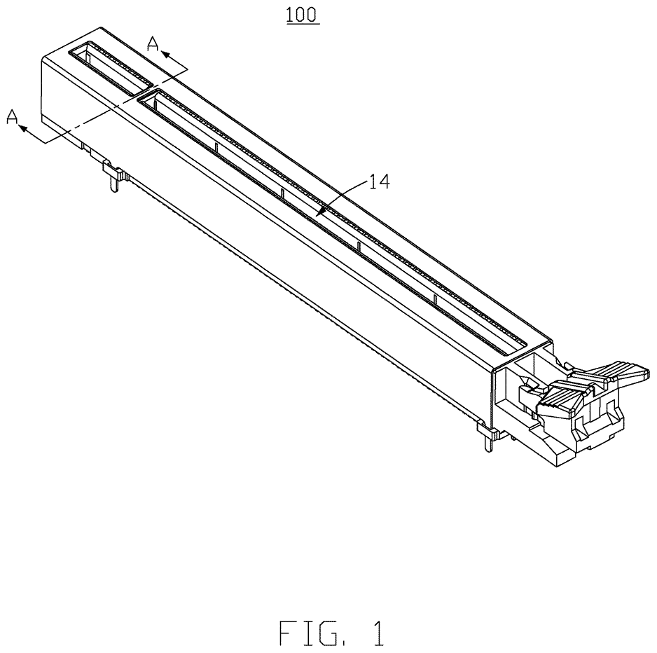

Referring to FIG. 1, a card edge connector 100 of an embodiment can be applied to a computer for connecting a computer motherboard to external hardware devices, so as to allow the external hardware devices to be connected to the computer motherboard. The card edge connector 100 can be an electrical connector mounted on the motherboard. In some embodiments, the card edge connector 100 can be a PCI-e connector.

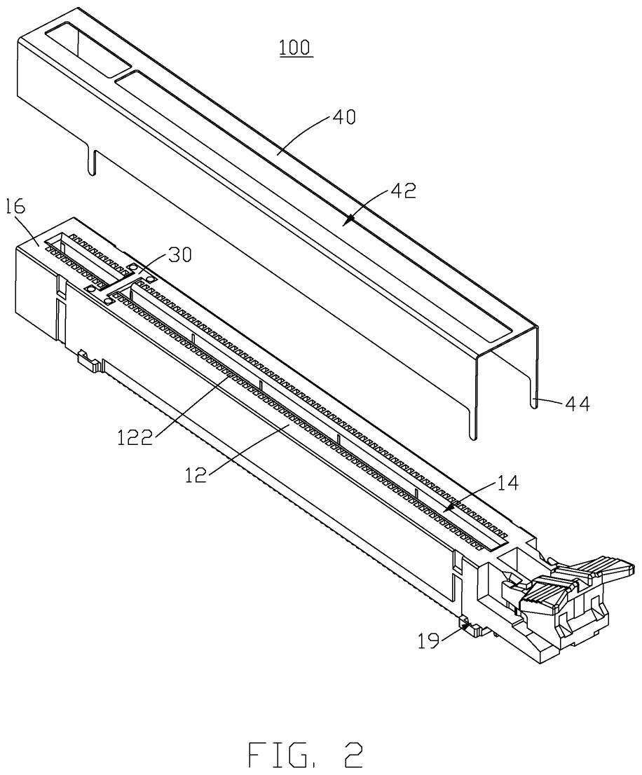

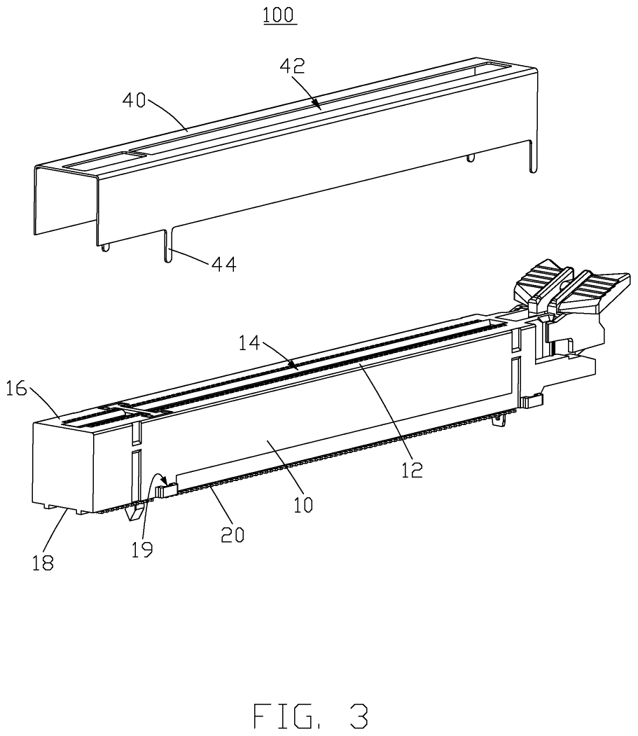

Referring to FIGS. 1, 2, and 3, the card edge connector 100 includes an insulating housing 10, two rows of conductive terminals 20, and a metal key 30. The insulating housing 10 has two opposing sidewalls 12, a mating face 16, and a mating slot 14 located between the two sidewalls 12 and penetrating through the mating face 16. The mating slot 14 has a lower inside 18 opposite to the mating face 16. In this embodiment, the mating face 16 can be a top surface of the insulating housing 10. In other embodiments, the mating slot 14 penetrates forward, the mating face 16 is a front face, and the insulating housing 10 is generally rectangular box-shaped. The mating slot 14 defines an insertion direction, which can be the direction from the mating face 16 toward the lower inside 18.

The conductive terminals 20 are located on the sidewalls 12 and include contacting portions 22 protruding into the mating slot 14. Each of the two sidewalls 12 has a plurality of passages 122, and the plurality of conductive terminals 20 are respectively accommodated in the passages 122. Each conductive terminal 20 has the contacting portion 22 protruding from the passage 122 into the mating slot 14. The mating slot 14 is used for receiving other electronic components, such as graphics cards, network adapter cards, storage controllers, etc. The contacting portions 22 protruding into the mating slot 14 are electrically connected to the inserted electronic components. The conductive terminals 20 also extend through the lower inside 18 of the insulating housing 10 for electrical connection with a motherboard (not shown), thereby achieving electrical connection between the card edge connector 100 and the motherboard.

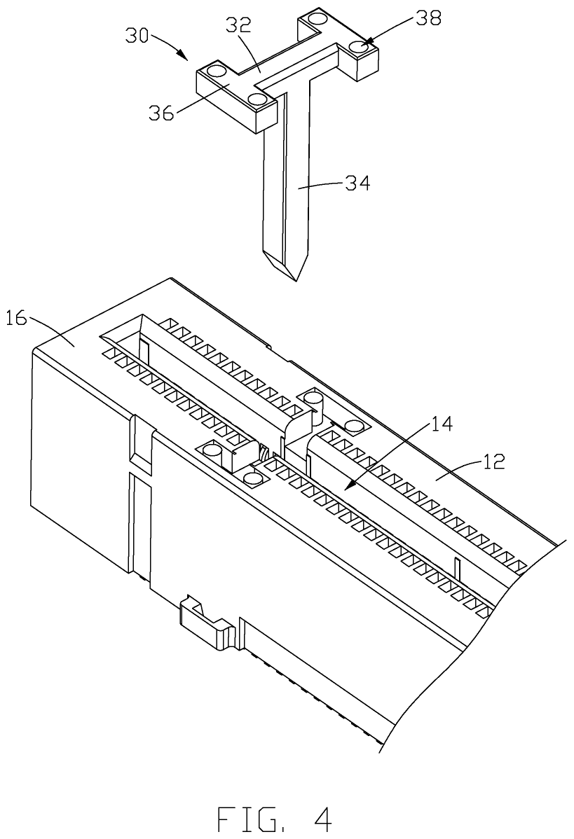

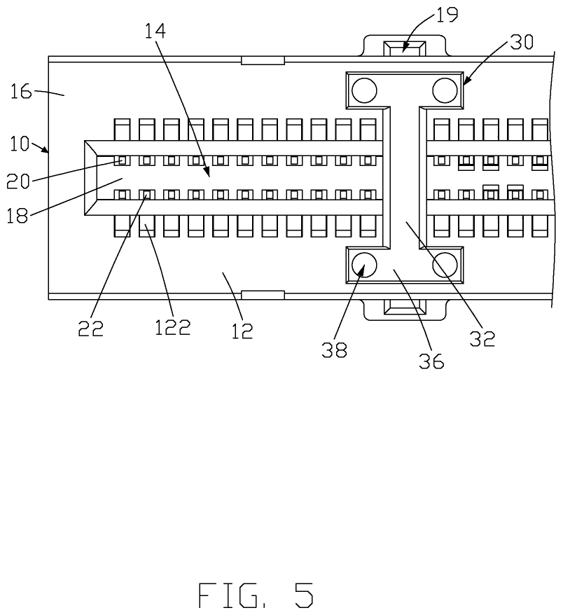

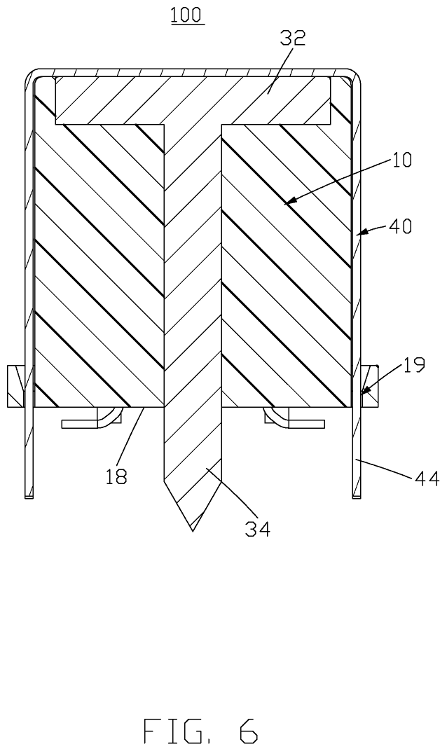

Referring to FIGS. 4, 5, and 6, the metal key 30 of a solid block, and extends laterally across the mating slot 14 and is embedded in the two sidewalls 12. The metal key 30 includes a horizontal bar 32 and a vertical bar 34. Both ends of the horizontal bar 32 are embedded in the two sidewalls 12. The vertical bar 34 is connected to the middle portion of the horizontal bar 32, and the connection between the horizontal bar 32 and the vertical bar 34 is generally T-shaped. Furthermore, the vertical bar 34 extends into the mating slot 14 and is attached to the insides of the two sidewalls 12.

In some embodiments, both ends of the horizontal bar 32 are embedded in the two sidewalls 12 and are flush with the mating face 16. The vertical bar 34 extends from the horizontal bar 32 into the mating slot 14, that is, extends from near the mating face 16 into the mating slot 14, and further extends through the lower inside 18. In some embodiments, a portion of the vertical bar 34 extending through the lower inside 18 can be further connected to the motherboard (not shown), thereby enhancing the stability of the connection between the card edge connector 100 and the motherboard.

In some embodiments, the metal key 30 includes side portions 36 located at opposite ends of the horizontal bar 32. The side portions 36 extend in a direction parallel to the sidewalls 12 and are embedded in the two sidewalls 12. The horizontal bar 32 and the side portions 36 are generally I-shaped, and the side portions 36 at opposite ends of the horizontal bar 32 increase the area embedded in the two sidewalls 12. The horizontal bar 32 spans the mating slot 14 between the two sidewalls 12, thereby increasing the stability of the connection between the metal key 30 and the sidewalls 12. In some embodiments, the horizontal bar 32 and the side portions 36 are flush with the mating face 16.

In some embodiments, the side portions 36 have two holes 38, and part of the material of the insulating housing 10 is fixed in the holes 38, thereby increasing the stability of the connection between the metal key 30 and the insulating housing 10.

In this embodiment, the metal key 30 is made of die-cast metal material and has a large thickness, thus providing high strength. The metal key 30 is first manufactured into the required structure. Subsequently, the insulating material is injection-molded onto the metal key 30, and after cooling, the insulating housing 10 is formed, and then the conductive terminals 20 are inserted. It can be understood that the insulating material fixes the metal key 30 during the injection molding process, so that the metal key 30 is embedded in the insulating housing 10.

The card edge connector 100 includes a metal shell 40. The metal shell 40 surrounds the insulating housing 10. The metal shell 40 has a slot 42 corresponding to the mating slot 14, so that when the metal shell 40 covers the insulating housing 10, the mating slot 14 is exposed. In some embodiments, the side plates of the metal shell 40 has a plurality of fixing legs 44 extending in the mating direction. The outside of the sidewall 12 of the insulating housing 10 has a plurality of fixing holes 19. The fixing legs 44 of the metal shell 40 correspondingly pass through the fixing holes 19 and extend beyond the lower inside 18. The fixing legs 44 can be used for connection with a motherboard (not shown). The metal shell simultaneously covers the mating face, the side portions and the horizontal bar.

The metal key 30 extends laterally through the mating slot 14 and is embedded in the two sidewalls 12, so that the metal key 30 is better combined with the insulating housing 10. The metal key 30 extends into the mating slot 14 and passes through the lower inside 18, thereby improving the connection stability of the card edge connector 100.

The above-mentioned embodiments are only preferred embodiments of the present invention, and should not limit the scope of the present invention, any simple equivalent changes and modifications made according to the claims of the present invention and the contents of the description should still belong to the present invention.

1. A card edge connector comprising:
an insulating housing having two sidewalls, a mating face, and a mating slot located between the two sidewalls penetrating through the mating face and defining a mating direction;
a plurality of conductive terminals located on the sidewalls and having contacting portions protruding into the mating slot; and
a metal key located on the insulating housing;
wherein the metal key is of a solid block, the solid block extends laterally across the mating slot and is embedded in the two sidewalls.

2. The card edge connector according to claim 1, wherein the metal key has a horizontal bar and a vertical bar, opposite ends of the horizontal bar are embedded in the sidewalls respectively, and the vertical bar extends into the mating slot and is attached to the inside of the sidewalls.

3. The card edge connector according to claim 2, wherein the mating slot has a lower inside opposite to the mating face, and the vertical bar extends through the lower inside.

4. The card edge connector according to claim 2, wherein the metal key has side portions located at opposite ends of the horizontal bar, the side portions extend in a direction parallel to the sidewalls and are embedded in the sidewalls.

5. The card edge connector according to claim 4, wherein the side portions have two holes, and parts of the insulating housing are filled and fixed in the holes.

6. The card edge connector according to claim 4, wherein the horizontal bar and the side portions are flush with the mating face.

7. The card edge connector according to claim 1, wherein the metal key is made of die-cast metal material.

8. The card edge connector according to claim 1, further comprising a metal shell surrounding the insulating housing.

9. A card edge connector comprising:
an insulating housing having two sidewalls, a mating face, and a mating slot located between the two sidewalls and opening through the mating face;
two rows of conductive terminals located on the sidewalls and have contacting portions protruding into the mating slot; and
a metal key extending laterally across the mating slot;
wherein the insulating housing is formed by an injection molding process of insulating material, the metal key is fixed in the insulating housing during the injection molding process.

10. The card edge connector according to claim 9, wherein the metal key is a die-cast.

11. The card edge connector according to claim 9, wherein the metal key has a horizontal bar and a vertical bar, opposite ends of the horizontal bar are embedded in the sidewalls, and the vertical bar extends in the mating slot and is attached to opposite insides of the sidewalls.

12. The card edge connector according to claim 11, wherein the mating slot has a lower inside opposite to the mating face, and the vertical bar extends through the lower inside.

13. The card edge connector according to claim 11, wherein the metal key has side portions located at opposite ends of the horizontal bar, the side portions extend in a direction parallel to the sidewalls and are embedded in the sidewalls.

14. The card edge connector according to claim 13, wherein the side portions have two holes, and parts of the insulating housing are filled and fixed in the holes.

15. The card edge connector according to claim 14, wherein the horizontal bar and the side portions are flush with the mating face.

16. The card edge connector according to claim 15, further comprising a metal shell surrounding the insulating housing, and wherein the metal shell simultaneously covers the mating face, the side portions, and the horizontal bar.
